(19) United States
(12) Patent Application Publication
(10) Pub. No.: US 2025/0351210 A1
(43) Pub. Date: Nov. 13, 2025

(54) STANDALONE NON-PUBLIC NETWORK SELECTION FOR DUAL ACCESS OF A NETWORK

(71) Applicant: QUALCOMM Incorporated, San Diego, CA (US)

(72) Inventors: Waqar ZIA, Munich (DE); Dario Serafino TONESI, San Diego, CA (US); Lenaig Genevieve CHAPONNIERE, La Jolla, CA (US); Amer CATOVIC, San Diego, CA (US); Haris ZISIMOPOULOS, London (IE); Sebastian SPEICHER, Wallisellen (CH); Ajith Tom PAYYAPPILLY, San Diego, CA (US)

(21) Appl. No.: 18/859,733

(22) PCT Filed: May 1, 2023
(86) PCT No.: PCT/US2023/066428

§ 371 Date: Oct. 24, 2024

(30) Foreign Application Priority Data
Jun. 14, 2022 (GR) 20220100491

(51) Int. Cl. H04W 76/15; H04W 8/24; H04W 48/18; H04W 84/04

(52) U.S. Cl. CPC H04W 76/15; H04W 8/24; H04W 48/18; H04W 84/042

(57) ABSTRACT

Method and devices for wireless communications are described. A user equipment, UE, establishes (1005) a first wireless connection with a network via a public land mobile network, PLMN. The UE selects (1010) a standalone non-public network, SNPN, for establishment of a dual wireless connection between the UE and the network from a set of SNPNs associated with dual access of the network. In some examples, the UE selects the SNPN from one or more prioritized lists that include or indicate SNPNs that support dual access of the network via the PLMN and one of the SNPNs. The UE establishes (1015) a second wireless connection with the network via the selected SNPN to establish the dual wireless connection with the first network.

### CROSS REFERENCE

The present Application is a 371 national stage filing of International PCT Application No. PCT/US2023/066428 by ZIA et al., entitled “STANDALONE NON-PUBLIC NETWORK SELECTION FOR DUAL ACCESS OF A NETWORK,” filed May 1, 2023; and claims priority to Greek patent Application No. 20220100491 by ZIA et al. entitled “STANDALONE NON-PUBLIC NETWORK SELECTION FOR DUAL ACCESS OF A NETWORK,” filed Jun. 14, 2022, each of which is assigned to the assignee hereof, and each of which is expressly incorporated by reference in its entirety herein.

### FIELD OF TECHNOLOGY

The following relates to wireless communications, including standalone non-public network (SNPN) selection for dual access of a network.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

In some wireless communications systems, a UE may be in the service area of two 3rd Generation Partnership Project (3GPP) networks. However, dual network access via the two 3GPP networks may be unsupported.

### SUMMARY

The described techniques relate to improved methods, systems, devices, and apparatuses that support standalone non-public network (SNPN) selection for dual access of a network. The described techniques provide for a user equipment (UE) to establish and maintain dual 3rd Generation Partnership Project (3GPP) access (DTA), which may support traffic steering, switching, and splitting via two 3GPP networks. For example, the UE may establish a first wireless connection with a network (e.g., a core network) via a public land mobile network (PLMN). The UE may select an SNPN for establishment of a dual wireless connection between the UE and the network. The UE may select the SNPN from a set of SNPNs associated with dual access of the network. That is, the set of SNPNs may include SNPNs that support the dual wireless connection via the PLMN and the SNPN. In some examples, the UE may select the SNPN from one or more prioritized lists that include or indicate SNPNs that support the dual wireless connection. Upon selection, the UE may establish a second wireless connection with the network via the SNPN to establish the dual wireless connection with the network and may communicate with the network via the dual wireless connection.

A method for wireless communication at a UE is described. The method may include establishing a first wireless connection with a first network via a PLMN, selecting an SNPN for establishment of a dual wireless connection between the UE and the first network, the dual wireless connection being via the SNPN and the PLMN, the SNPN selected from a set of SNPNs associated with dual access of the first network, and establishing a second wireless connection with the first network via the SNPN to establish the dual wireless connection with the first network.

An apparatus for wireless communication at a UE is described. The apparatus may include a processor, memory coupled with the processor, and instructions stored in the memory. The instructions may be executable by the processor to cause the apparatus to establish a first wireless connection with a first network via a PLMN, select an SNPN for establishment of a dual wireless connection between the UE and the first network, the dual wireless connection being via the SNPN and the PLMN, the SNPN selected from a set of SNPNs associated with dual access of the first network, and establish a second wireless connection with the first network via the SNPN to establish the dual wireless connection with the first network.

Another apparatus for wireless communication at a UE is described. The apparatus may include means for establishing a first wireless connection with a first network via a PLMN, means for selecting an SNPN for establishment of a dual wireless connection between the UE and the first network, the dual wireless connection being via the SNPN and the PLMN, the SNPN selected from a set of SNPNs associated with dual access of the first network, and means for establishing a second wireless connection with the first network via the SNPN to establish the dual wireless connection with the first network.

A non-transitory computer-readable medium storing code for wireless communication at a UE is described. The code may include instructions executable by a processor to establish a first wireless connection with a first network via a PLMN, select an SNPN for establishment of a dual wireless connection between the UE and the first network, the dual wireless connection being via the SNPN and the PLMN, the SNPN selected from a set of SNPNs associated with dual access of the first network, and establish a second wireless connection with the first network via the SNPN to establish the dual wireless connection with the first network.

In some examples of the method, apparatuses, and non-transitory computer-readable medium described herein, selecting the SNPN from the set of SNPNs may include operations, features, means, or instructions for selecting the SNPN in accordance with a prioritized list of SNPNs, at least a portion of the prioritized list of SNPNs overlapping with the set of SNPNs.

In some examples of the method, apparatuses, and non-transitory computer-readable medium described herein, selecting the SNPN from the set of SNPNs may include operations, features, means, or instructions for selecting a group identifier (GIN) in accordance with a prioritized list of GINs associated with the set of SNPNs and selecting the SNPN based on receiving, from the SNPN, a broadcast associated with the GIN.

Some examples of the method, apparatuses, and non-transitory computer-readable medium described herein may further include operations, features, means, or instructions for operating in a mode associated with dual access of the first network via SNPNs, where selecting the SNPN from the set of SNPNs may be triggered based on operating in the mode.

Some examples of the method, apparatuses, and non-transitory computer-readable medium described herein may further include operations, features, means, or instructions for receiving, from the PLMN, a UE route selection policy (URSP) that triggers the selection of the SNPN for establishment of the dual wireless connection between the UE and the first network.

In some examples of the method, apparatuses, and non-transitory computer-readable medium described herein, the set of SNPNs may be associated with the PLMN.

In some examples of the method, apparatuses, and non-transitory computer-readable medium described herein, a list including the set of SNPNs includes an identifier of the PLMN, the SNPN selected from the set of SNPNs in the list based on the list including the identifier of the PLMN.

In some examples of the method, apparatuses, and non-transitory computer-readable medium described herein, a first subset of SNPNs of the set of SNPNs correspond to SNPNs included in a prioritized list of SNPNs for establishment of the dual wireless connection, a second subset of SNPNs of the set of SNPNs correspond to SNPNs associated with a prioritized list of GINs, and the first subset of SNPNs may be associated with a higher priority for selection to establish the dual wireless connection than the second subset of SNPNs.

Some examples of the method, apparatuses, and non-transitory computer-readable medium described herein may further include operations, features, means, or instructions for receiving a first message that indicates the set of SNPNs.

Some examples of the method, apparatuses, and non-transitory computer-readable medium described herein may further include operations, features, means, or instructions for replacing a second set of SNPNs associated with dual access of the first network with the set of SNPNs in response to receiving the first message.

Some examples of the method, apparatuses, and non-transitory computer-readable medium described herein may further include operations, features, means, or instructions for transmitting a second message indicating a capability of the UE to update stored SNPN information associated with selection of the SNPN for establishment of the dual wireless connection, where the first message may be received based on the capability of the UE to update the stored SNPN information.

In some examples of the method, apparatuses, and non-transitory computer-readable medium described herein, the first message includes an indication of a quantity of SNPNs in the set of SNPNs, a list of SNPNs for establishment of the dual wireless connection included in the set of SNPNs, a list of GINs associated with SNPNs for establishment of the dual wireless connection included in the set of SNPNs, or a combination thereof.

In some examples of the method, apparatuses, and non-transitory computer-readable medium described herein, the first message includes an indication of whether the first message includes the list of SNPNs, an indication of whether the first message includes the list of GINs, an indication of whether the list of SNPNs includes an identifier of the PLMN, an indication of whether the list of GINs includes the identifier of the PLMN, or a combination thereof.

In some examples of the method, apparatuses, and non-transitory computer-readable medium described herein, the first message may be a steering of roaming SNPN selection information (SOR-SNPN-SI) message.

### BRIEF DESCRIPTION OF THE DRAWINGS

FIGS. 1 and 2 illustrate examples of wireless communications systems that support standalone non-public network (SNPN) selection for dual access of a network in accordance with one or more aspects of the present disclosure.

FIG. 3 illustrates an example of a selection diagram that supports SNPN selection for dual access of a network in accordance with one or more aspects of the present disclosure.

FIG. 4 illustrates an example of a message diagram that supports SNPN selection for dual access of a network in accordance with one or more aspects of the present disclosure.

FIG. 5 illustrates an example of a process flow that supports SNPN selection for dual access of a network in accordance with one or more aspects of the present disclosure.

FIGS. 6 and 7 show block diagrams of devices that supports SNPN selection for dual access of a network in accordance with one or more aspects of the present disclosure.

FIG. 8 shows a block diagram of a communications manager that supports SNPN selection for dual access of a network in accordance with one or more aspects of the present disclosure.

FIG. 9 shows a diagram of a system including a device that supports SNPN selection for dual access of a network in accordance with one or more aspects of the present disclosure.

FIGS. 10 through 12 show flowcharts illustrating methods that support SNPN selection for dual access of a network in accordance with one or more aspects of the present disclosure.

### DETAILED DESCRIPTION

In some wireless communications systems, a user equipment (UE) may support concurrent dual access to a network (e.g., a core network) via a 3rd Generation Partnership Project (3GPP) network and a non-3GPP network (e.g., a wireless local area network (WLAN, among other non-3GPP networks). For example, the UE may implement an access traffic steering, switch and splitting (ATSSS) protocol that enables the UE to maintain a dual connection with a network via a public land mobile network (PLMN) and a non-3GPP network, such as a Wi-Fi network. Such dual connectivity may support increased capacity, data rates, and flexibility, while reducing latency, for example, by supporting steering of traffic between the 3GPP and non-3GPP networks, handover between the networks without service interruption, and concurrent usage of both the 3GPP and non-3GPP networks.

However, in some cases, a non-3GPP network may be unavailable to support such a dual connection or may lack the capacity to support a quantity and/or type of traffic communicated over such a dual connection. For the example, the non-3GPP network may support voice services, while other types of traffic services, such as video services and internet services, may be unsupported by the non-3GPP network (e.g., due to the relatively large quantities of traffic associated with video and internet services compared to voice services). Thus, it may be beneficial for the UE to maintain dual-3GPP access (DTA) via two different 3GPP networks.

For example, the UE may be connected to the core network via a PLMN while also being in the service area of one or more standalone non-public networks (SNPNs). A non-public network may be a network that enables network deployment (e.g., 5G network deployment, among others) for private use. An SNPN may be a non-public network managed (e.g., and deployed) by an non-public network operator or an operator of a PLMN that does not rely on network functions provided by the PLMN to provide access to the core network. It may be advantageous for the UE to concurrently (e.g., simultaneously) connect to the PLMN and the SNPN, for example, to support traffic steering, switching, and splitting of various types of traffic (e.g., voice, internet, and video services, among other services), among other benefits. However, selection procedures for connecting to an SNPN may not support DTA by the UE. That is, in accordance with current SNPN selection procedure, the UE may select an SNPN for which dual connection with the core network via the PLMN and the selected SNPN is unsupported.

The techniques, devices, and methods described herein may enable a UE to support DTA via a PLMN and a SNPN. That is, the UE may establish and maintain a dual wireless connection between the UE and a network via the PLMN and the SNPN. For example, the UE may establish a first wireless connection with the network via a PLMN. To establish the dual wireless connection, the UE may perform a DTA SNPN selection procedure that supports the selection of a DTA SNPN (e.g., an SNPN that supports DTA). For example, the UE select the SNPN from a set of SNPNs that are associated with dual access of the network. That is, the set of SNPNs may include SNPNs that support the aggregation and switching of traffic with the PLMN. The UE may establish a second wireless connection with the network via the selected SNPN to establish the dual wireless connection.

In some examples, the UE may store one or more prioritized lists for the DTA SNPN selection procedure that include information to support the selection of a DTA SNPN. For example, the UE may store one or more prioritized lists of DTA SNPNs, one or more prioritized lists of DTA group identifiers (GINs), or both. The UE may select an SNPN indicated by one of the lists (e.g., a DTA SNPN, an SNPN associated with a DTA GIN) that corresponds to the PLMN via which the UE established the first wireless connection and establish a second wireless connection via the SNPN. Accordingly, by establishing connections with a network via the PLMN and the selected SNPN, the UE may establish, via two 3GPP networks, a dual wireless connection with the network that supports traffic steering, switching, and steering.

Aspects of the present disclosure may be implemented to realize one or more advantages. For example, a UE establishing and maintaining DTA with a network via a PLMN and an SNPN may support the routing of traffic between the PLMN or the SNPN (e.g., based on quality of service (QoS) metrics), handover between the PLMN and SNPN without service interruption, and concurrent data communication via the PLMN and SNPN. As a result, data rates, capacity, and coverage may be increased, latency may be reduced, and a resource sharing may be improved.

Aspects of the disclosure are initially described in the context of wireless communications systems. Aspects of the disclosure are additionally described in the context of a selection diagram, a message diagram, and a process flow. Aspects of the disclosure are further illustrated by and described with reference to apparatus diagrams, system diagrams, and flowcharts that relate to SNPN selection for dual access of a network.

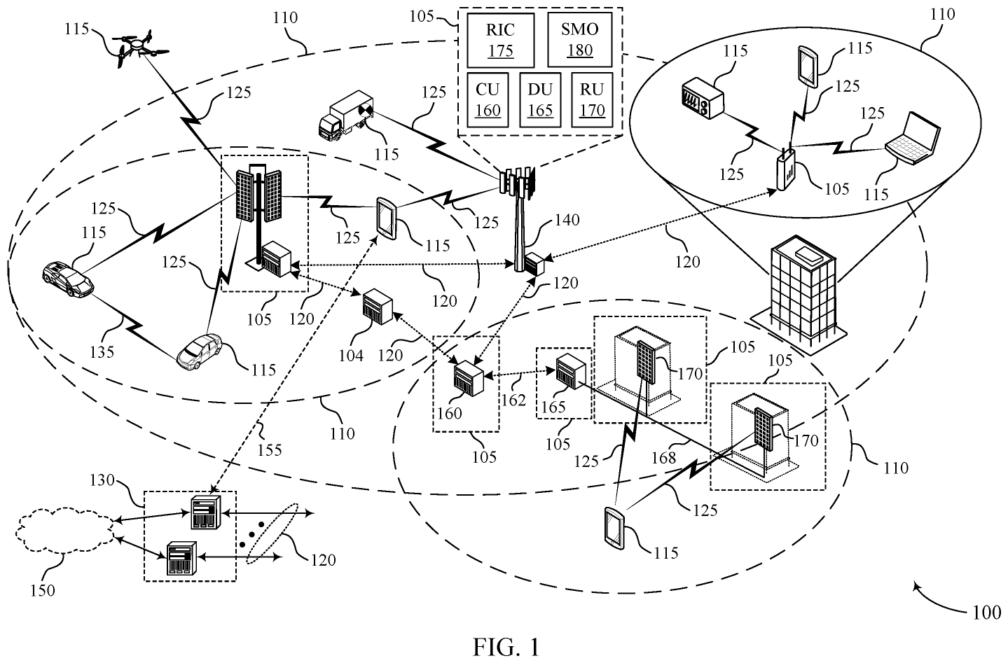

FIG. 1 illustrates an example of a wireless communications system 100 that supports SNPN selection for dual access of a network in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending upon which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1,F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support SNPN selection for dual access of a network as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given RAT (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and Ne may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

In some examples, the wireless communications system 100 may include or be an example of a PLMN that supports access of the core network 130 by a UE 115. For example, a PLMN may be a cellular network managed by a network operator within a geographic location (e.g., Verizon, AT&T, T-Mobile, among other network operators). A PLMN may support one or multiple RATs via which a UE 115 may access the core network 130.

In some examples, the wireless communications system 100 may include or be an example of one or more SNPNs that support access of the core network 130 by a UE 115. For example, an SNPN may be a non-public network (e.g., a private network) that does not rely on network functions provided by a PLMN to provide access to the core network 130. That is, the SNPN may include one or more network functions that are independent of the network functions included in a PLMN and that may support user authentication, access authorization, tracking, IP connectivity, and other access, routing, or mobility functions. In some examples, an SNPN may be managed (e.g., and deployed) by a same network operator that manages an associated PLMN. In some examples, an SNPN may be managed (e.g., and deployed) by a different network operator (e.g., a non-public network operator) than a network operator that manages an associated PLMN.

Various aspects of the described techniques support the establishment of a dual wireless connection between a UE 115 and the core network 130 via a PLMN and an SNPN. For example, the UE 115 may establish a first wireless connection with the core network 130 via a PLMN. To establish the dual wireless connection, the UE 115 may select an SNPN from a set of DTA SNPNs and establish a second wireless connection with the core network 130 via the selected SNPN. In some examples, the set of DTA SNPNs may be a subset of SNPNs via which the UE 115 may establish a wireless connection with the core network 130 that are prioritized for selection based on supporting dual access of the core network 130 in conjunction with the PLMN. The first and second wireless connections may be concurrently maintained and utilized to communicate information between the UE 115 and the core network 130 and may thus together constitute the dual wireless connection.

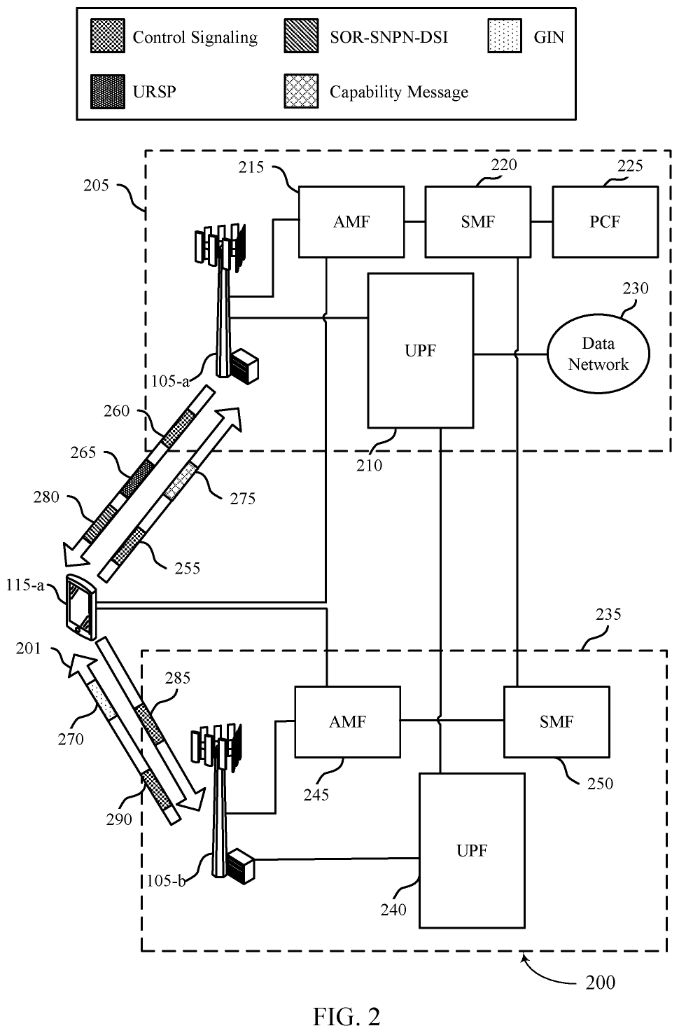

FIG. 2 illustrates an example of a wireless communications system 200 that supports SNPN selection for dual access of a network in accordance with one or more aspects of the present disclosure. The wireless communications system 200 may implement or be implemented by aspects of wireless communications system 100 with reference to FIG. 1. For example, the wireless communications system 200 may include a network entity 105-a, a network entity 105-b, and a UE 115-a which may be examples of the corresponding devices described herein, including with reference to FIG. 1.

The wireless communications system 200 may support communications between the UE 115 and the network entities 105. For example, the UE 115 may communicate downlink and uplink messages with the network entities 105 via respective communication links 201, which may be examples of a communication link 125 described with reference to FIG. 1.

The wireless communications system 200 may include a PLMN 205 within which the network entity 105-a may operate. The PLMN 205 may include the network entity 105-a and one or more network functions, such as a UPF 210, an AMF 215, a session management function (SMF) 220, and a policy control function (PCF) 225, among other network functions. The AMF 215 may be a control plane entity that manages access, mobility, and NAS functions, among other functions. The SMF 220 may be a control plane entity that provides protocol data unit (PDU) session management services, IP address allocation services, downlink notification management services, and general packet radio service (GPRS) tunnelling protocol user (GTP-U) services, among others, in conjunction with the AMF 215 and the UPF 210. The PCF 225 may provide policy rules for control plane entities in the PLMN 205 (e.g., network functions in a core network) and subscription management services, among others. The UPF 210 may be a user plane entity that routes packets or interconnects to external networks, such as a data network 230, which may be an example of IP services 150 described with reference to FIG. 1.

The PLMN 205 may provide the UE 115-a with access to a core network (e.g., a core network 130) and the data network 230. For example, communications between the UE 115-a and the data network 230 may be routed via the network entity 105-a and communications between the network entity 105-a and the data network 230 may be routed via the UPF 210. In some examples, the UE 115-a may communicate with the AMF 215 via a transparent interface, such as an N1 interface.

The wireless communications system 200 may also include one or more SNPNs 235 via which the UE 115-a may access the data network 230. For example, the wireless communications system 200 may include an SNPN 235 within which the network entity 105-b may operate. In some examples, the SNPN 235 may be managed by a non-public network operator or the same network operator that manages the PLMN 205. Additionally, the SNPN 235 may include one or more other network functions than those provided by the PLMN 205 to provide the UE 115-a with access to the data network 230. For example, the SNPN 235 may include a UPF 240, an AMF 245, and an SMF 250. The SMF 250 may communicate with the SMF 220. Additionally, the UPF 240 may communicate with the UPF 210. In some examples, the UPF 210 may be referred to as a PDU session anchor (PSA) for the PLMN 205 and the SNPN 235. That is, the UPF 210 may be the UPF that directly interfaces with the data network 230, and communications between the UPF 240 and the data network 230 may be routed via the UPF 210. Thus, communications between the UE 115-a and the data network 230 via the SNPN 235 may be routed via the network entity 105-b and the UPF 240.

In some cases, the UE 115-a may be in the service area of both the PLMN 205 and the SNPN 235. Accordingly, the UE 115-a may support establishing wireless connections with a network (e.g., a core network, the data network 230) via one or both of the PLMN 205 and the SNPN 235. In some examples, the service area covered by the PLMN 205 and the SNPN 235 may be a permanent or a temporary dual coverage. The PLMN 205 and the SNPN 235 may provide 3GPP access to the UE 115-a using same or different RATs. For example, the RAT used to communicate may be the same at both the PLMN 205 and the SNPN 235 (e.g., NR and NR, non-terrestrial network (NTN) and NTN, among other RATs). Alternatively, the RAT used to communicate may be different for the PLMN 205 and the SNPN 235 (e.g., NR and LTE, NR and NTN, among other RATs).

Additionally, the UE 115-a may support dual subscription or single subscription. For example, the UE 115-a may include multiple subscriber identity modules (SIMs) (e.g., two SIMs), such as multiple universal SIMs (USIMs). Here, the UE 115-a may be referred to as a multi-USIM (MUSIM) device. Each SIM may include subscription information according to which the UE 115-a may establish a network connection (e.g., a wireless connection with a network, such as a core network, data network 230, or both). In some examples, the UE 115-a may include a single SIM (e.g., a single USIM) that the UE 115-a may use to establish a network connection (e.g., via the PLMN 205). Here, mobile equipment (ME) of the UE 115-a (e.g., components of the UE 115-a besides any SIMs) may include non-USIM credential information (e.g., an international mobile subscriber identity (IMSI), among other authentication credential information) that may be used to establish a network connection via an SNPN 235. In some examples, ME of the UE 115-a may include credential information for establishing a network connection via an SNPN 235 in addition to including multiple SIMs. Accordingly, the dual or single subscription UE 115-a may establish network connections via the PLMN 205, the SNPN 235, or both.

In some examples, it may be advantageous for the UE 115-a to establish a dual wireless connection with a network (e.g., a dual network connection) via both the PLMN 205 and the SNPN 235, for example, to support traffic steering, switching, and splitting via two 3GPP networks. For example, if the UE 115-a is outside the service area of a non-3GPP network (e.g., a Wi-Fi network), the UE 115-a may still support traffic steering, switching, and splitting if able to establish a dual wireless connection via two 3GPP networks. However, using current SNPN selection techniques, the UE 115-a may select an SNPN 235 that does not support DTA. For example, a selection order according to which the UE 115-a may select an SNPN 235 may be: the SNPN with which the UE 115-a was last registered, an SNPN 235 identified by an SNPN identity in a selected entry of a “list of subscriber data” configured in the ME, and so on. However, such a selection order may result in the UE 115-a selecting an SNPN 235 that does not support DTA. For example, in some cases, to support DTA, operators of a PLMN 205 and an SNPN 235 may coordinate (e.g., in accordance with a business agreement between the operators) such that aggregation and switching traffic is supported via the PLMN 205 and the SNPN 235. However, current SNPN selection procedures may result in the selection of an SNPN 235 for which such coordination has not occurred. Additionally or alternatively, current SNPN selection procedure may result in the selection of an SNPN 235 that lacks the capacity to various types of traffic to be communicated via a dual connection. Thus, the current SNPN selection procedure may not address the DTA case of aggregation and switching traffic with the PLMN 205.

To support dual network access, the UE 115-a may establish DTA with the PLMN 205 and the SNPN 235 in accordance with a DTA SNPN selection procedure. For example, the UE 115-a may transmit control signaling 255 to the network entity 105-a and the network entity 105-a may transmit control signaling 260 to the UE 115-a to establish a first wireless connection with the network via the PLMN 205, for example, as part of a random access channel (RACH) procedure. After establishing the first wireless connection via the PLMN 205, the UE 115-a may select the SNPN 235 for establishment of a dual wireless connection with the network in accordance with the DTA SNPN selection procedure. In some cases, selecting the SNPN 235 in accordance with the DTA SNPN selection procedure may be based on the UE 115-a operating in a mode associated with dual access of the network via SNPNs 235, which may be referred to as a DTA SNPN access mode. That is, operating in the DTA SNPN access mode may trigger the UE 115-a to select the SNPN 235 in accordance with the DTA SNPN selection procedure. In some other cases, the network entity 105-a may transmit a UE route selection policy (URSP) 265 to the UE 115-a, for example, as part of establishment of the first wireless connection. The URSP 265 may include one or more rules that trigger the UE 115-a to select the SNPN 235 in accordance with the DTA SNPN selection procedure. In some examples, the URSP 265 may indicate for the UE 115-a to enter the DTA SNPN access mode.

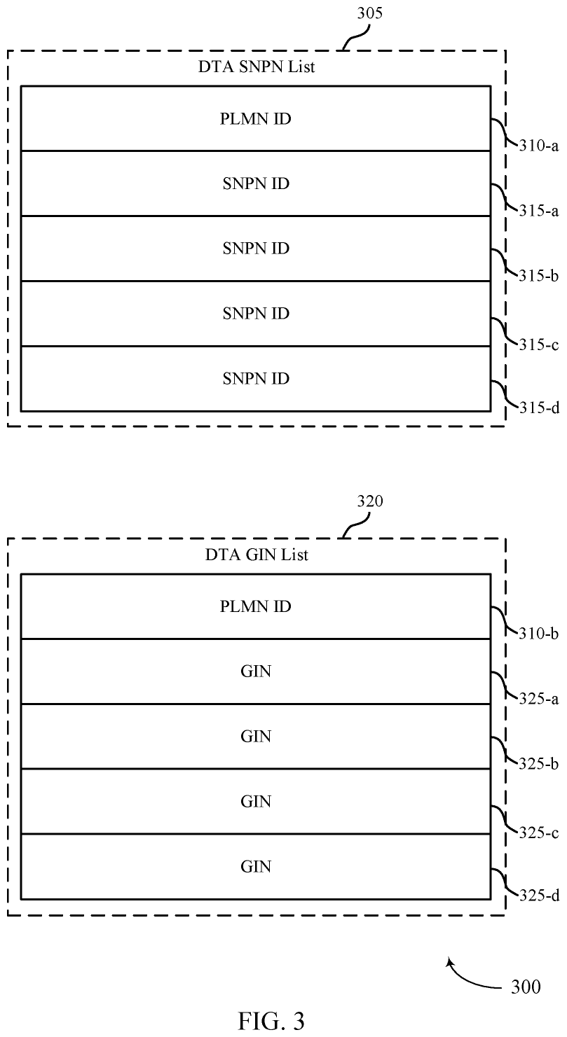

To select the SNPN 235 in accordance with the DTA SNPN selection procedure, the UE 115-a may be configured with or otherwise store a set of DTA SNPNs from which the UE 115-a may select the SNPN 235. For example, the UE 115-amay be configured with or otherwise store a DTA SNPN list (e.g., a prioritized list of DTA SNPNs), a DTA GIN list (e.g., a prioritized list of DTA GINs), or both, from which to select the SNPN 235. In some cases, the network entity 105-b of the SNPN 235 may broadcast a GIN 270 to the UE 115-a. The GIN 270 may be a group identifier for network selection that is associated with the SNPN 235. Accordingly, the UE 115-a may receive the GIN 270 and compare the GIN 270 to GINs included in the DTA GIN list in association with selection of the SNPN 235. Additional details associated with selection of the SNPN 235 using prioritized lists are included with reference to FIG. 3 below.

In some cases, the UE 115-a may transmit a capability message 275 to the network entity 105-a indicating a capability of the UE 115-a to update stored DTA SNPN selection information (e.g., the DTA SNPN list, the DTA GIN list, or both). For example, the update stored DTA SNPN selection information, the network entity 105-a may transmit a steering of roaming-SNPN-DTA selection information (SOR-SNPN-DSI) 280 to the UE 115-a indicating an update to the DTA SNPN list, the DTA GIN list, or both. In some examples, the network entity 105-a may transmit the SOR-SNPN-DSI 280 based on (e.g., in response to) receiving the capability message 275. In some examples, the capability message 275 may indicate that updating the stored DTA SNPN selection information is unsupported by the UE 115-a, and the network entity 105-a may not transmit a SOR-SNPN-DSI 280 to the UE 115-a.

Upon selecting the SNPN 235, the UE 115-a may attempt to establish a second wireless connection with the network via the SNPN 235. For example, the UE 115-a may transmit control signaling 285 to the network entity 105-b and the network entity 105-b may transmit control signaling 290 to the UE 115-a to establish the second wireless connection with the network via the SNPN 235, for example, as part of a RACH procedure. If the establishment of the second wireless connection is successful, the UE 115-a may communicate with the network via the first wireless connection and the second wireless connection that together constitute the dual wireless connection. If the establishment of the second wireless connection is unsuccessful, the UE 115-a may select another SNPN 235 from the set of DTA SNPNs in accordance with the DTA SNPN selection procedure, attempt to establish the second wireless connection via the other SNPN 235, and so on, for example, until the dual wireless connection is successfully established.

In some cases, the network entity 105-a may be associated with (e.g., included in) both the PLMN 205 and the SNPN 235. In such cases, the UE 115-a may communicate with the network entity 105-a to establish the dual wireless connection with the network via the PLMN 205 and the SNPN 235.

FIG. 3 illustrates an example of a selection diagram 300 that supports SNPN selection for dual access of a network in accordance with one or more aspects of the present disclosure. The selection diagram 300 may be implemented by aspects of the wireless communications systems 100 and 200 as described herein with reference to FIGS. 1 and 2. For example, the selection diagram 300 may be implemented by a UE 115, which may be an example of a UE 115 described herein.

In some implementations, the UE 115 may operate in a DTA SNPN access mode and be configured with DTA SNPN selection parameters. The DTA SNPN selection parameters may include one or more of a DTA SNPN list 305 and a DTA GIN list 320. In some examples, the ME of the UE 115 may be configured with the DTA SNPN selection parameters.

The DTA SNPN list 305 may be a prioritized list of DTA SNPNs from which the UE 115 may select an SNPN to establish a dual wireless connection with a network. The DTA SNPN list 305 may include one or more entries of SNPN identifiers (IDs) 315 that each correspond to an ID of a DTA SNPN. In the example of FIG. 3, the DTA SNPN list 305 may include an SNPN ID 315-a corresponding to a first DTA SNPN, an SNPN ID 315-b corresponding to a second DTA SNPN, an SNPN ID 315-c corresponding to a third DTA SNPN, and an SNPN ID 315-d corresponding to a fourth DTA SNPN (although any other quantity of SNPN IDs 315 may be included in the DTA SNPN list 305). In some examples, an entry of the DTA SNPN list 305 (e.g., the first entry) may contain a PLMN ID 310-a corresponding to a primary PLMN (e.g., the PLMN via which the UE 115 establishes a first wireless connection with the network).

The DTA GIN list 320 may be a prioritized list of DTA GINs that the UE 115 may use to select a corresponding SNPN to establish the dual wireless connection. For example, the DTA GIN list 320 may include one or more entries of GINs 325 that may be used in the selection of a DTA SNPN. In the example of FIG. 3, the DTA GIN list 320 may include a GIN 325-a corresponding to a first DTA GIN, a GIN 325-b corresponding to a second DTA GIN, a GIN 325-c corresponding to a third DTA GIN, and a GIN 325-d corresponding to a fourth DTA GIN (although any other quantity of GINs 325 may be included in the DTA GIN list 320). In some examples, an entry of the DTA GIN list 320 (e.g., the first entry of the DTA GIN list 320 may contain a PLMN ID 310-b of the corresponding primary PLMN. In some examples, the PLMN ID 310-a and the PLMN ID 310-b may be a same PLMN ID 310.

The UE 115 may use the DTA SNPN list 305, the DTA GIN list 320, or both to select a DTA SNPN in accordance with a DTA SNPN selection procedure (e.g., triggered based on operating according to the DTA SNPN access mode). For example, ME of the UE 115 may be configured with a “list of subscriber data” containing zero or more entries. Each entry in the list of subscriber data may include a subscriber identifier (e.g., containing a network-specific identifier or an IMSI), credentials (e.g., available in a USIM), an SNPN identity of the subscribed SNPN, one or more prioritized list of SNPNs, one or more prioritized list of GINs, or a combination thereof, among other parameters that may be included in each entry of the list of subscriber data. In some examples, the DTA SNPN selection procedure may include that if: there is at least one entry in a list of subscriber data; or there are zero or more entries in the list of subscriber data and the UE has a USIM with a PLMN subscription; and the ME is provisioned (e.g., configured) with SNPN selection parameters associated with the PLMN subscription, the UE 115 may select one entry in the list of subscriber data, if any, or the PLMN subscription, if any, to be used for DTA SNPN selection.

The selected entry may include one or more prioritized lists of SNPNs, one or more prioritized lists of GINS, or a combination thereof. For example, the selected entry may include the DTA SNPN list 305, the DTA GIN list 320, or a combination thereof, among other prioritized lists that may be included in the selected entry. In accordance with the DTA SNPN selection procedure, the UE 115 may select a DTA SNPN for establishment of the dual wireless connection from the DTA SNPN list 305, the DTA GIN list 320, or both. In an example, the UE 115 may select an SNPN, if available and allowable, according to the following order: each SNPN which is identified by the SNPN IDs 315 included in the DTA SNPN list 305 (in priority order) that has a PLMN ID 310-a that matches the primary PLMN; each SNPN which broadcasts a GIN 325 included in the DTA GIN list 320 (in priority order) that has a PLMN ID 310-b that matches the primary PLMN. Other selection orders are possible. For example, the UE 115 may select SNPNs which broadcasts GINs 325 prior to selecting SNPNs identified by the SNPN IDs 315. Alternatively, the DTA SNPN list 305 or the DTA GIN list 320 may be excluded from the selected entry and the UE 115 may select an SNPN (e.g., in priority order) from an included DTA prioritized list.

Each SNPN ID 315 may be prioritized in a preferred order within the DTA SNPN list 305 (e.g., arranged in a priority order according to which the UE 115 may select the SNPN IDs 315). For example, in an example in which earlier entries of the DTA SNPN list 305 have a higher priority than subsequent entries, the SNPN ID 315-a may be associated with a highest priority, the SNPN ID 315-b may be associated with a next highest priority, and so on. Other priority orders are possible. Similarly, each GIN 325 may be prioritized in preferred order within the DTA GIN list 320. In some cases, more than one SNPN may broadcast the same GIN 325. Here, the order in which the UE attempts registration on those SNPNs may be determined by the UE. In some examples, the UE may limit the search for SNPNs to those that support next generation-RAN (NG-RAN) access technologies.

Once the UE 115 has selected the SNPN from either the DTA SNPN list 305 or the DTA GIN list 320, the UE 115 may attempt registration on (e.g., to establish a connection with a network via) the selected SNPN using the NG-RAN access technology and the subscriber identifier and credentials selected from the list of subscriber data or from the USIM. If the UE 115 is successful in registering with the SNPN, the UE may indicate the selected SNPN to the network entity. In some examples, if the UE 115 is unsuccessful in registering with the selected SNPN, the UE 115 may select a next SNPN in accordance with the selection order of the DTA selection procedure an attempt registration on the next selected SNPN.

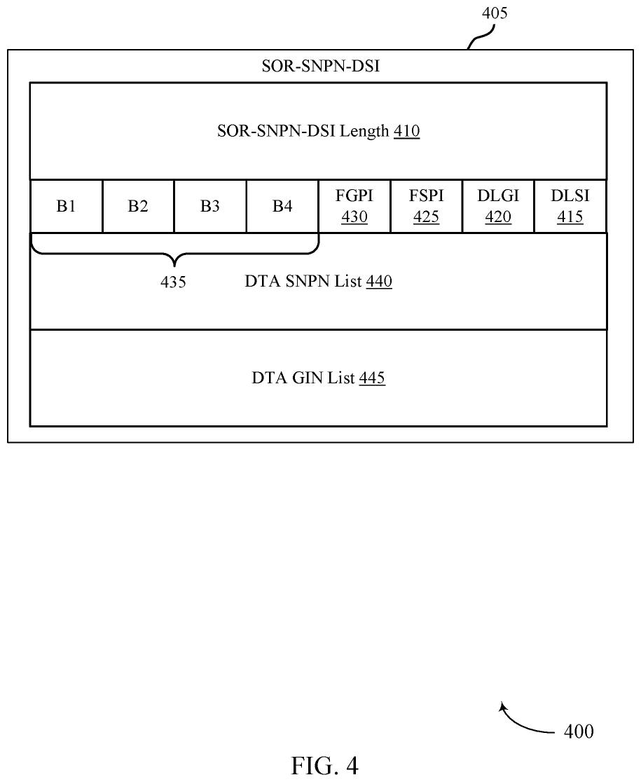

FIG. 4 illustrates an example of a message diagram 400 that supports SNPN selection for dual access of a network in accordance with one or more aspects of the present disclosure. The message diagram 400 may be implemented by aspects of the wireless communications systems 100 and 200 as described herein with reference to FIGS. 1 and 2, respectively. For example, the message diagram 400 may be implemented by a UE 115 and a network entity 105, which may be examples of the corresponding devices described herein, to communicate a SOR-SNPN-DSI 405, which may be an example of a SOR-SNPN-DSI 280 described with reference to FIG. 2.

Communication of the SOR-SNPN-DSI 405 may enable the updating (e.g., configuration) of one or more prioritized lists of DTA SNPNs (e.g., a DTA SNPN list 305), one or more prioritized lists of DTA GINs (e.g., a DTA GIN list 320), or a combination thereof. For example, the network entity 105 may transmit the SOR-SNPN-DSI 405 to the UE 115 to update DTA SNPN selection information (e.g., one or more prioritized DTA lists for selection of a DTA SNPN in accordance with a DTA SNPN selection procedure). The network entity 105 may update DTA SNPN selection information via the SOR-SNPN-DSI 405 for a UE 115 that has the same PLMN subscription (e.g., PLMN credentials holder) or separate subscribed SNPNs.

To support updating DTA SNPN selection information, current DTA SNPN selection information may be retrieved (e.g., by the network entity 105, a network function) via a unified data management (UDM) function or a SOR application function (SOR-AF). That is, the network entity 105 may retrieve the current DTA SNPN selection information to determine current DTA SNPN lists, DTA GIN lists, or a combination thereof, that are stored by the UE 115. Based on retrieving the DTA SNPN selection information, the network entity 105 may determine whether to update at least part of the DTA SNPN selection information and what updated DTA SNPN selection information to send to the UE 115.

The network entity 105 may send the updated DTA SNPN selection information via the SOR-SNPN-DSI 405. For example, the SOR-SNPN-DSI 405 may include one or more DTA SNPN lists 440, a DTA GIN lists 445, or a combination thereof. The UE 115 may update stored DTA SNPN selection information with the updated DTA SNPN selection information indicated via the SOR-SNPN-DSI 405. For example, the UE 115 may replace a stored DTA SNPN list with the DTA SNPN list 440, a stored DTA GIN list with the DTA GIN list 445, or a combination thereof. In some examples, replacing stored DTA SNPN selection information (e.g., DTA SNPN and/or GIN lists) may include replacing DTA SNPN selection information included in an entry of a “list of subscriber data” or associated with a selected PLMN subscription with the updated DTA SNPN selection information included in the SOR-SNPN-DSI 405.

In some examples, the network entity 105 may transmit the SOR-SNPN-DSI 405 based on a capability of the UE 115. For example, the network entity 105 may receive a capability message from the UE 115 that indicates whether the UE 115 supports receiving the SOR-SNPN-DSI 405 (e.g., updating stored DTA SNPN selection information) and may transmit the SOR-SNPN-DSI 405 based on the UE 115 indicating support for receiving the SOR-SNPN-DSI 405.

In some examples, the network entity 105 may indicate transmission (e.g., a presence) of the SOR-SNPN-DSI 405 via a SOR transparent container. For example, a SOR transparent container may include an indication (e.g., a SOR-SNPN-DSI indicator (SSDSI) value) that indicates transmission of the SOR-SNPN-DSI 405 (e.g., whether the SOR transparent container includes the SOR-SNPN-DSI 405). The UE may receive the SOR transparent container and decode the SSDSI. If the SSDSI is set to a first value (e.g., ‘1’), the UE may determine the presence of the SOR-SNPN-DSI 405 for reception. If the SSDSI is set to a second value (e.g., ‘0’), the UE may determine that no SOR-SNPN-DSI is present. In some examples, if the SOR-SNPN-DSI 405 is not present (e.g., if no change of the DTA SNPN selection information stored at the UE 115 is warranted and thus no SOR-SNPN-DSI is provided), the SOR transparent container may exclude the SSDSI to indicate the absence of the SOR-SNPN-DSI 405.

The SOR-SNPN-DSI 405 may include various parameters that support updating the DTS SNPN selection information. For example, the SOR-SNPN-DSI 405 may include an SOR-SNPN-DSI length 410, a DTA prioritized list of SNPNs indicator (DLSI) 415, a DTA prioritized list of GINs indicator (DLGI) 420, a first entry DTA prioritized list of SNPNs PLMN ID (FSPI) 425, and a first entry DTA prioritized list of GINs primary PLMN ID (FGPI) 430, one or more spare bits 435, or a combination thereof. Additionally, the SOR-SNPN-DSI 405 may include the DTA SNPN list 440 and the DTA GIN list 445.

The UE 115 may decode the SOR-SNPN-DSI length 410 to determine the size of the SOR-SNPN-DSI 405 (e.g., a quantity of bits of the SOR-SNPN-DSI 405. In some examples, if the SOR-SNPN-DSI length 410 indicates a length larger than a threshold quantity of bits (e.g., a threshold quantity of octets of bits), the UE may ignore the remaining portion of bits (e.g., octets) located at the end of the SOR-SNPN-DSI 405. If the DLSI 415 is set to a first value (e.g., ‘1’), the DTA SNPN list 440 may be present in the SOR-SNPN-DSI 405, otherwise the DTA SNPN list 440 may be absent (e.g., excluded) from the SOR-SNPN-DSI 405. Likewise, if the DLGI 420 is set to a first value (e.g., ‘1’), the DTA GIN list 445 may be present in the SOR-SNPN-DSI 405, otherwise the DTA GIN list 445 may be absent from the SOR-SNPN-DSI 405. The UE 115 may check the FSPI 425 to verify if an entry (e.g., the first entry) in the DTA SNPN list 440 is the primary PLMN ID. For example, if the FSPI 425 is set to a first value (e.g., ‘1’), the first entry of the DTA SNPN list 440 may be the primary PLMN ID, otherwise the PLMN ID may be absent from the DTA SNPN list 440. Similarly, the UE 115 may check the FGPI 430 to verify whether the first entry in the DTA GIN list 445 corresponds to the primary PLMN ID.

Accordingly, by communicating the SOR-SNPN-DSI 405, DTA SNPN selection information may be updated, which may increase a flexibility of the DTA SNPN selection procedure and support adaptation, for example, based on local conditions at the UE 115.

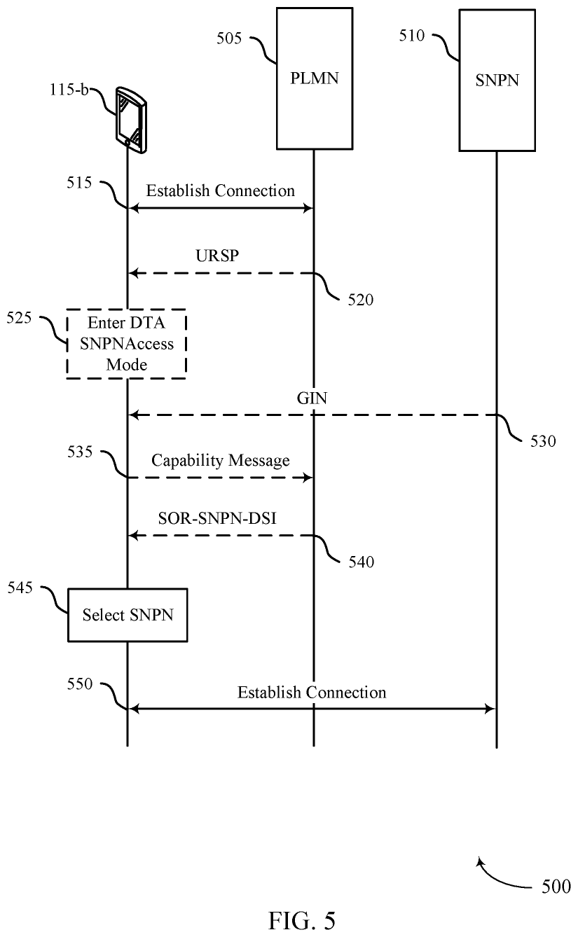

FIG. 5 illustrates an example of a process flow 500 that supports SNPN selection for dual access of a network in accordance with one or more aspects of the present disclosure. The process flow 500 may implement or be implemented by aspects of the wireless communications systems 100 and 200 as described herein, including with reference to FIGS. 1 through 4. For example, the process flow 500 may include a UE 115-b, a PLMN 505, and an SNPN 510, which may be an example of the corresponding aspects described herein.

In the following description of the process flow 500, the operations may be performed in different orders or at different times. Some operations also may be omitted from the process flow 500, and other operations may be added to the process flow 500. Further, although some operations or signaling may be shown to occur at different times for discussion purposes, these operations may actually occur at the same time.

At 515, the UE 115-b may establish a connection with a first network via the PLMN 505. For example, the UE 115-b and a network entity 105 included in the PLMN 505 may communicate control signaling (e.g., including subscription information) to register the UE 115-b with the PLMN 505 and enable access to the first network via the PLMN 505.

At 520, the PLMN 505 may transmit a URSP to the UE 115-b triggering the selection of the SNPN 510 for establishment of a dual wireless connection between the UE 115-b and the first network. That is, the URSP may indicate that the UE 115-b is to select the SNPN 510 in accordance with a DTA SNPN selection procedure. At 525, the UE 115-b may enter a mode associated with dual access of the first network via the SNPN 510 (e.g., a DTA SNPN access mode). For example, the UE 115-b may be triggered to select the SNPN 510 for establishment of the dual wireless connection in accordance with the DTA SNPN selection procedure based on operating in the DTA access mode. In some examples, the UE 115-b may enter the DTA SNPN access mode in response to receiving the URSP. In some examples, the UE 115-b may enter the DTA SNPN access mode independent of the URSP. In some examples, the UE 115-b may be configured to continually (e.g., always) operate in DTA SNPN access mode (e.g., prior to establishing the connection with the PLMN 505).

At 530, the SNPN 510 may broadcast a GIN to the UE 115-b. For example, a network entity 105 of the SNPN 510 may broadcast the GIN. Based on receiving the broadcasted GIN, the UE 115-b may determine that the GIN is associated with the SNPN 510.

At 535, the UE 115-b may transmit a capability message indicating a capability of the UE 115-b to update stored SNPN information associated with selection of the SNPN 510 for establishment of the dual wireless connection (e.g., stored DTA SNPN selection information). For example, the capability message may be an example of an SOR acknowledgment message indicating the capability of the UE to receive SOR-SNPN-DSI messages.

At 540, the PLMN 505 may transmit a first message that indicates a set of SNPNs based on receiving the capability message. The first message may be an example of a SOR-SNPN-DSI message. For example, the PLMN may transmit a SOR-SNPN-DSI message indicating an update to the set of prioritized lists used for SNPN selection (e.g., a prioritized list of SNPNs, a prioritized list of GINs). In some cases, the first message may include an indication of a quantity of SNPNs in the set of SNPNs, a list of SNPNs for dual wireless connection, a list of GINs associated with the SNPNs, or a combination thereof. In some examples, the first message may also include an indication of whether the first message includes the list of SNPNs, an indication of whether the first message includes the list of GINs, an indication of whether the list of the SNPN includes a PLMN ID associated with the PLMN 505, an indication of whether the list of GINs includes a PLMN ID associated with the PLMN 505, or a combination thereof. The UE 115-b may replace the set of prioritized lists used for SNPN selection with the set of SNPNs indicated in the first message based on receiving the first message.

At 545, the UE 115-b may select the SNPN 510 for establishment of the dual wireless connection, where the UE has a dual wireless connection with the first network via the SNPN 510 and the PLMN 505. For example, the UE 115-b may select the SNPN 510 from a set of DTA SNPNs (e.g., a stored set of DTA SNPNs, the updated set of DTA SNPNs) in accordance with a prioritized list of DTA SNPNs (e.g., a DTA SNPN list) that may overlap with the set SNPNs. For instance the prioritized list of DTA SNPNs may be a subset of the set of DTA SNPNs. Additionally, or alternatively, the UE 115-b may select the SNPN 510 in accordance with a prioritized list of GINs. In some cases, the set of SNPNs may be associated with the PLMN.

At 550, the UE 115-b may establish a second wireless connection with the first network via the SNPN 510 to establish the dual wireless connection via the PLMN 505 and the SNPN 510 and may communicate with the first network via the dual wireless connection.

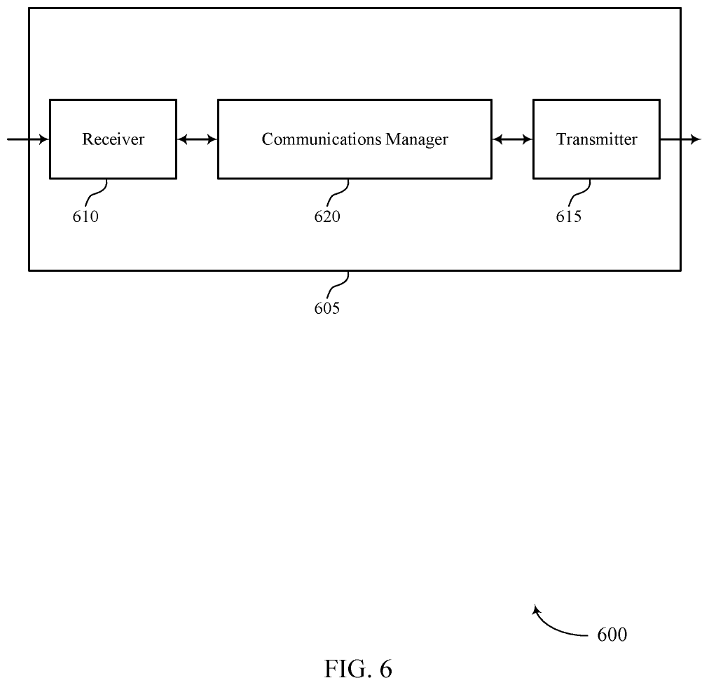

FIG. 6 shows a block diagram 600 of a device 605 that supports SNPN selection for dual access of a network in accordance with one or more aspects of the present disclosure. The device 605 may be an example of aspects of a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to SNPN selection for dual access of a network). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to SNPN selection for dual access of a network). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations thereof or various components thereof may be examples of means for performing various aspects of SNPN selection for dual access of a network as described herein. For example, the communications manager 620, the receiver 610, the transmitter 615, or various combinations or components thereof may support a method for performing one or more of the functions described herein.

In some examples, the communications manager 620, the receiver 610, the transmitter 615, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 620, the receiver 610, the transmitter 615, or various combinations or components thereof may be implemented in code (e.g., as communications management software or firmware) executed by a processor. If implemented in code executed by a processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communication at a UE in accordance with examples as disclosed herein. For example, the communications manager 620 may be configured as or otherwise support a means for establishing a first wireless connection with a first network via a PLMN. The communications manager 620 may be configured as or otherwise support a means for selecting a SNPN for establishment of a dual wireless connection between the UE and the first network, the dual wireless connection being via the SNPN and the PLMN, the SNPN selected from a set of SNPNs associated with dual access of the first network. The communications manager 620 may be configured as or otherwise support a means for establishing a second wireless connection with the first network via the SNPN to establish the dual wireless connection with the first network.

By including or configuring the communications manager 620 in accordance with examples as described herein, the device 605 (e.g., a processor controlling or otherwise coupled with the receiver 610, the transmitter 615, the communications manager 620, or a combination thereof) may support techniques for more efficient utilization of communication resources, for example, by supporting the steering, switching, and splitting of traffic via two 3GPP networks.

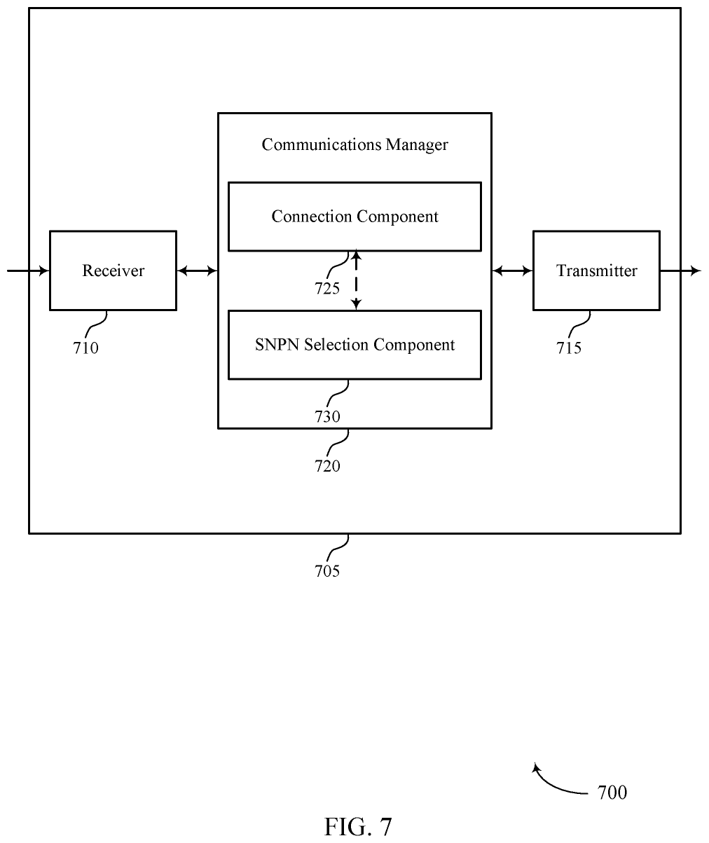

FIG. 7 shows a block diagram 700 of a device 705 that supports SNPN selection for dual access of a network in accordance with one or more aspects of the present disclosure. The device 705 may be an example of aspects of a device 605 or a UE 115 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to SNPN selection for dual access of a network). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to SNPN selection for dual access of a network). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of SNPN selection for dual access of a network as described herein. For example, the communications manager 720 may include a connection component 725, an SNPN selection component 730, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communication at a UE in accordance with examples as disclosed herein. The connection component 725 may be configured as or otherwise support a means for establishing a first wireless connection with a first network via a PLMN. The SNPN selection component 730 may be configured as or otherwise support a means for selecting a SNPN for establishment of a dual wireless connection between the UE and the first network, the dual wireless connection being via the SNPN and the PLMN, the SNPN selected from a set of SNPNs associated with dual access of the first network. The connection component 725 may be configured as or otherwise support a means for establishing a second wireless connection with the first network via the SNPN to establish the dual wireless connection with the first network.

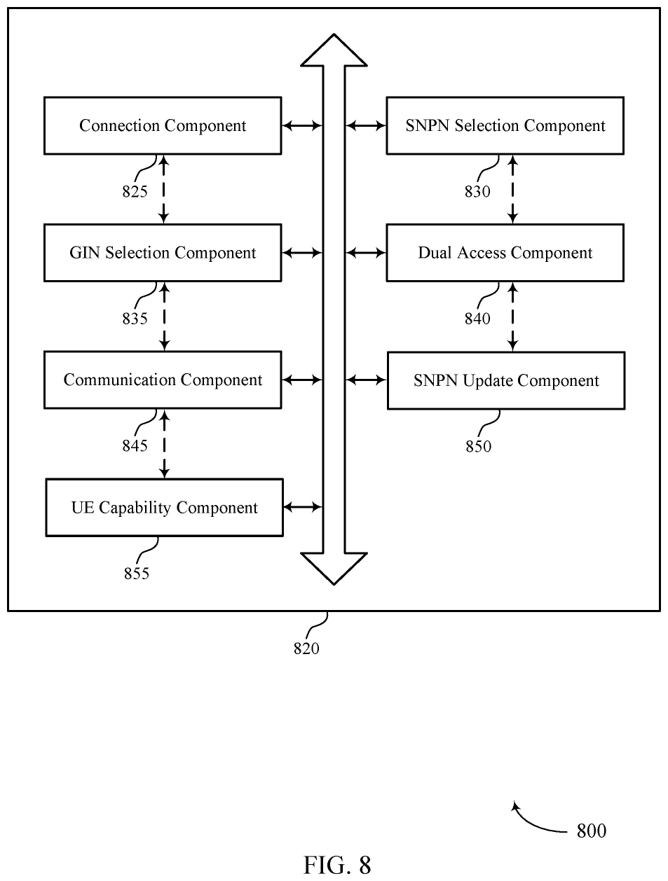

FIG. 8 shows a block diagram 800 of a communications manager 820 that supports SNPN selection for dual access of a network in accordance with one or more aspects of the present disclosure. The communications manager 820 may be an example of aspects of a communications manager 620, a communications manager 720, or both, as described herein. The communications manager 820, or various components thereof, may be an example of means for performing various aspects of SNPN selection for dual access of a network as described herein. For example, the communications manager 820 may include a connection component 825, an SNPN selection component 830, a GIN selection component 835, a dual access component 840, a communication component 845, an SNPN update component 850, a UE capability component 855, or any combination thereof. Each of these components may communicate, directly or indirectly, with one another (e.g., via one or more buses).

The communications manager 820 may support wireless communication at a UE in accordance with examples as disclosed herein. The connection component 825 may be configured as or otherwise support a means for establishing a first wireless connection with a first network via a PLMN. The SNPN selection component 830 may be configured as or otherwise support a means for selecting a SNPN for establishment of a dual wireless connection between the UE and the first network, the dual wireless connection being via the SNPN and the PLMN, the SNPN selected from a set of SNPNs associated with dual access of the first network. In some examples, the connection component 825 may be configured as or otherwise support a means for establishing a second wireless connection with the first network via the SNPN to establish the dual wireless connection with the first network.

In some examples, to support selecting the SNPN from the set of SNPNs, the SNPN selection component 830 may be configured as or otherwise support a means for selecting the SNPN in accordance with a prioritized list of SNPNs, at least a portion of the prioritized list of SNPNs overlapping with the set of SNPNs.

In some examples, to support selecting the SNPN from the set of SNPNs, the GIN selection component 835 may be configured as or otherwise support a means for selecting a GIN in accordance with a prioritized list of GINs associated with the set of SNPNs. In some examples, to support selecting the SNPN from the set of SNPNs, the SNPN selection component 830 may be configured as or otherwise support a means for selecting the SNPN based on receiving, from the SNPN, a broadcast associated with the GIN.

In some examples, the dual access component 840 may be configured as or otherwise support a means for operating in a mode associated with dual access of the first network via SNPNs, where selecting the SNPN from the set of SNPNs is triggered based on operating in the mode.

In some examples, the dual access component 840 may be configured as or otherwise support a means for receiving, from the PLMN, a URSP that triggers the selection of the SNPN for establishment of the dual wireless connection between the UE and the first network.

In some examples, the set of SNPNs are associated with the PLMN.

In some examples, a list including the set of SNPNs includes an identifier of the PLMN, the SNPN selected from the set of SNPNs in the list based on the list including the identifier of the PLMN.

In some examples, a first subset of SNPNs of the set of SNPNs correspond to SNPNs included in a prioritized list of SNPNs for establishment of the dual wireless connection, a second subset of SNPNs of the set of SNPNs correspond to SNPNs associated with a prioritized list of GINs, and the first subset of SNPNs is associated with a higher priority for selection to establish the dual wireless connection than the second subset of SNPNs.

In some examples, the communication component 845 may be configured as or otherwise support a means for receiving a first message that indicates the set of SNPNs.

In some examples, the SNPN update component 850 may be configured as or otherwise support a means for replacing a second set of SNPNs associated with dual access of the first network with the set of SNPNs in response to receiving the first message.

In some examples, the UE capability component 855 may be configured as or otherwise support a means for transmitting a second message indicating a capability of the UE to update stored SNPN information associated with selection of the SNPN for establishment of the dual wireless connection, where the first message is received based on the capability of the UE to update the stored SNPN information.

In some examples, the first message includes an indication of a quantity of SNPNs in the set of SNPNs, a list of SNPNs for establishment of the dual wireless connection included in the set of SNPNs, a list of GINs associated with SNPNs for establishment of the dual wireless connection included in the set of SNPNs, or a combination thereof.

In some examples, the first message includes an indication of whether the first message includes the list of SNPNs, an indication of whether the first message includes the list of GINs, an indication of whether the list of SNPNs includes an identifier of the PLMN, an indication of whether the list of GINs includes the identifier of the PLMN, or a combination thereof.

In some examples, the first message is a SOR-SNPN-SI message.

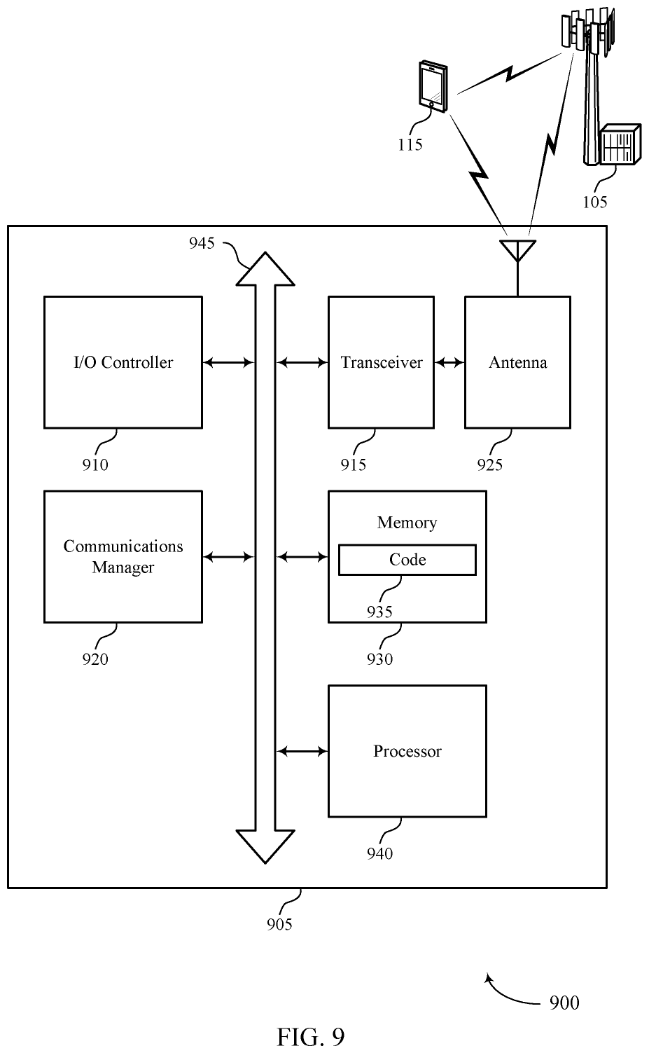

FIG. 9 shows a diagram of a system 900 including a device 905 that supports SNPN selection for dual access of a network in accordance with one or more aspects of the present disclosure. The device 905 may be an example of or include the components of a device 605, a device 705, or a UE 115 as described herein. The device 905 may communicate (e.g., wirelessly) with one or more network entities 105, one or more UEs 115, or any combination thereof. The device 905 may include components for bi-directional voice and data communications including components for transmitting and receiving communications, such as a communications manager 920, an input/output (I/O) controller 910, a transceiver 915, an antenna 925, a memory 930, code 935, and a processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally or alternatively, the I/O controller 910 may represent or interact with a modem, a keyboard, a mouse, a touchscreen, or a similar device. In some cases, the I/O controller 910 may be implemented as part of a processor, such as the processor 940. In some cases, a user may interact with the device 905 via the I/O controller 910 or via hardware components controlled by the I/O controller 910.

In some cases, the device 905 may include a single antenna 925. However, in some other cases, the device 905 may have more than one antenna 925, which may be capable of concurrently transmitting or receiving multiple wireless transmissions. The transceiver 915 may communicate bi-directionally, via the one or more antennas 925, wired, or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The memory 930 may include random access memory (RAM) and read-only memory (ROM). The memory 930 may store computer-readable, computer-executable code 935 including instructions that, when executed by the processor 940, cause the device 905 to perform various functions described herein. The code 935 may be stored in a non-transitory computer-readable medium such as system memory or another type of memory. In some cases, the code 935 may not be directly executable by the processor 940 but may cause a computer (e.g., when compiled and executed) to perform functions described herein. In some cases, the memory 930 may contain, among other things, a basic I/O system (BIOS) which may control basic hardware or software operation such as the interaction with peripheral components or devices.

The processor 940 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 940 may be configured to operate a memory array using a memory controller. In some other cases, a memory controller may be integrated into the processor 940. The processor 940 may be configured to execute computer-readable instructions stored in a memory (e.g., the memory 930) to cause the device 905 to perform various functions (e.g., functions or tasks supporting SNPN selection for dual access of a network). For example, the device 905 or a component of the device 905 may include a processor 940 and memory 930 coupled with or to the processor 940, the processor 940 and memory 930 configured to perform various functions described herein.

The communications manager 920 may support wireless communication at a UE in accordance with examples as disclosed herein. For example, the communications manager 920 may be configured as or otherwise support a means for establishing a first wireless connection with a first network via a PLMN. The communications manager 920 may be configured as or otherwise support a means for selecting a SNPN for establishment of a dual wireless connection between the UE and the first network, the dual wireless connection being via the SNPN and the PLMN, the SNPN selected from a set of SNPNs associated with dual access of the first network. The communications manager 920 may be configured as or otherwise support a means for establishing a second wireless connection with the first network via the SNPN to establish the dual wireless connection with the first network.

By including or configuring the communications manager 920 in accordance with examples as described herein, the device 905 may support techniques for improved communication reliability, reduced latency, increased data rates, increased capacity, increased coverage, improved resource sharing, and more efficient utilization of communication resources, among other benefits.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the processor 940, the memory 930, the code 935, or any combination thereof. For example, the code 935 may include instructions executable by the processor 940 to cause the device 905 to perform various aspects of SNPN selection for dual access of a network as described herein, or the processor 940 and the memory 930 may be otherwise configured to perform or support such operations.

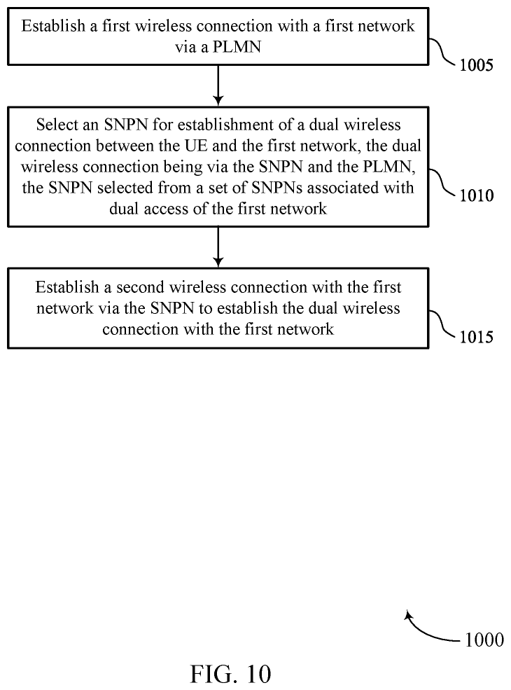

FIG. 10 shows a flowchart illustrating a method 1000 that supports SNPN selection for dual access of a network in accordance with one or more aspects of the present disclosure. The operations of the method 1000 may be implemented by a UE or its components as described herein. For example, the operations of the method 1000 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1005, the method may include establishing a first wireless connection with a first network via a PLMN. The operations of 1005 may be performed in accordance with examples as disclosed herein. In some examples, aspects of the operations of 1005 may be performed by a connection component 825 as described with reference to FIG. 8.

At 1010, the method may include selecting a SNPN for establishment of a dual wireless connection between the UE and the first network, the dual wireless connection being via the SNPN and the PLMN, the SNPN selected from a set of SNPNs associated with dual access of the first network. The operations of 1010 may be performed in accordance with examples as disclosed herein. In some examples, aspects of the operations of 1010 may be performed by an SNPN selection component 830 as described with reference to FIG. 8.

At 1015, the method may include establishing a second wireless connection with the first network via the SNPN to establish the dual wireless connection with the first network. The operations of 1015 may be performed in accordance with examples as disclosed herein. In some examples, aspects of the operations of 1015 may be performed by a connection component 825 as described with reference to FIG. 8.

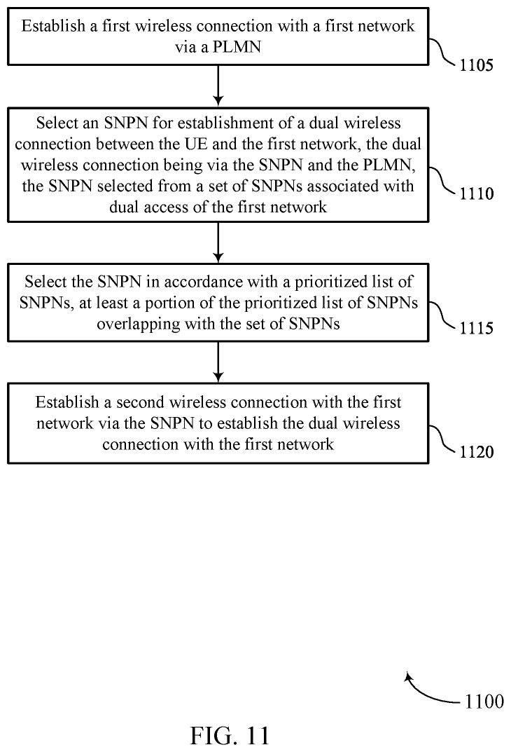

FIG. 11 shows a flowchart illustrating a method 1100 that supports SNPN selection for dual access of a network in accordance with one or more aspects of the present disclosure. The operations of the method 1100 may be implemented by a UE or its components as described herein. For example, the operations of the method 1100 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1105, the method may include establishing a first wireless connection with a first network via a PLMN. The operations of 1105 may be performed in accordance with examples as disclosed herein. In some examples, aspects of the operations of 1105 may be performed by a connection component 825 as described with reference to FIG. 8.

At 1110, the method may include selecting a SNPN for establishment of a dual wireless connection between the UE and the first network, the dual wireless connection being via the SNPN and the PLMN, the SNPN selected from a set of SNPNs associated with dual access of the first network. The operations of 1110 may be performed in accordance with examples as disclosed herein. In some examples, aspects of the operations of 1110 may be performed by an SNPN selection component 830 as described with reference to FIG. 8.

At 1115, to support selecting the SNPN, the method may include selecting the SNPN in accordance with a prioritized list of SNPNs, at least a portion of the prioritized list of SNPNs overlapping with the set of SNPNs. The operations of 1115 may be performed in accordance with examples as disclosed herein. In some examples, aspects of the operations of 1115 may be performed by an SNPN selection component 830 as described with reference to FIG. 8.

At 1120, the method may include establishing a second wireless connection with the first network via the SNPN to establish the dual wireless connection with the first network. The operations of 1120 may be performed in accordance with examples as disclosed herein. In some examples, aspects of the operations of 1120 may be performed by a connection component 825 as described with reference to FIG. 8.

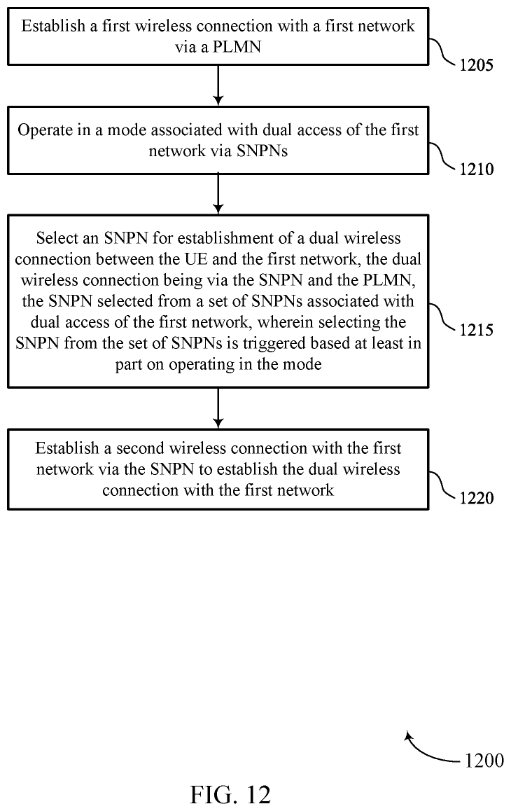

FIG. 12 shows a flowchart illustrating a method 1200 that supports SNPN selection for dual access of a network in accordance with one or more aspects of the present disclosure. The operations of the method 1200 may be implemented by a UE or its components as described herein. For example, the operations of the method 1200 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1205, the method may include establishing a first wireless connection with a first network via a PLMN. The operations of 1205 may be performed in accordance with examples as disclosed herein. In some examples, aspects of the operations of 1205 may be performed by a connection component 825 as described with reference to FIG. 8.

At 1210, the method may include operating in a mode associated with dual access of the first network via SNPNs. The operations of 1210 may be performed in accordance with examples as disclosed herein. In some examples, aspects of the operations of 1210 may be performed by a dual access component 840 as described with reference to FIG. 8.

At 1215, the method may include selecting a SNPN for establishment of a dual wireless connection between the UE and the first network, the dual wireless connection being via the SNPN and the PLMN, the SNPN selected from a set of SNPNs associated with dual access of the first network, where selecting the SNPN from the set of SNPNs is triggered based at least in part on operating in the mode. The operations of 1215 may be performed in accordance with examples as disclosed herein. In some examples, aspects of the operations of 1215 may be performed by an SNPN selection component 830 as described with reference to FIG. 8.

At 1220, the method may include establishing a second wireless connection with the first network via the SNPN to establish the dual wireless connection with the first network. The operations of 1220 may be performed in accordance with examples as disclosed herein. In some examples, aspects of the operations of 1220 may be performed by a connection component 825 as described with reference to FIG. 8.

The following provides an overview of aspects of the present disclosure:

Aspect 1: A method for wireless communication at a UE, comprising: establishing a first wireless connection with a first network via a PLMN; selecting a SNPN for establishment of a dual wireless connection between the UE and the first network, the dual wireless connection being via the SNPN and the PLMN, the SNPN selected from a set of SNPNs associated with dual access of the first network; and establishing a second wireless connection with the first network via the SNPN to establish the dual wireless connection with the first network.

Aspect 2: The method of aspect 1, wherein selecting the SNPN from the set of SNPNs comprises: selecting the SNPN in accordance with a prioritized list of SNPNs, at least a portion of the prioritized list of SNPNs overlapping with the set of SNPNs.

Aspect 3: The method of any of aspects 1 through 2, wherein selecting the SNPN from the set of SNPNs comprises: selecting a GIN in accordance with a prioritized list of GINs associated with the set of SNPNs; and selecting the SNPN based at least in part on receiving, from the SNPN, a broadcast associated with the GIN.

Aspect 4: The method of any of aspects 1 through 3, further comprising: operating in a mode associated with dual access of the first network via SNPNs, wherein selecting the SNPN from the set of SNPNs is triggered based at least in part on operating in the mode.

Aspect 5: The method of any of aspects 1 through 4, further comprising: receiving, from the PLMN, a URSP that triggers the selection of the SNPN for establishment of the dual wireless connection between the UE and the first network.

Aspect 6: The method of any of aspects 1 through 5, wherein the set of SNPNs are associated with the PLMN.

Aspect 7: The method of any of aspects 1 through 6, wherein a list comprising the set of SNPNs comprises an identifier of the PLMN, the SNPN selected from the set of SNPNs in the list based at least in part on the list comprising the identifier of the PLMN.

Aspect 8: The method of any of aspects 1 through 7, wherein a first subset of SNPNs of the set of SNPNs correspond to SNPNs included in a prioritized list of SNPNs for establishment of the dual wireless connection, a second subset of SNPNs of the set of SNPNs correspond to SNPNs associated with a prioritized list of GINs, and the first subset of SNPNs is associated with a higher priority for selection to establish the dual wireless connection than the second subset of SNPNs.

Aspect 9: The method of any of aspects 1 through 8, further comprising: receiving a first message that indicates the set of SNPNs.

Aspect 10: The method of aspect 9, further comprising: replacing a second set of SNPNs associated with dual access of the first network with the set of SNPNs in response to receiving the first message.

Aspect 11: The method of any of aspects 9 through 10, further comprising: transmitting a second message indicating a capability of the UE to update stored SNPN information associated with selection of the SNPN for establishment of the dual wireless connection, wherein the first message is received based at least in part on the capability of the UE to update the stored SNPN information.

Aspect 12: The method of any of aspects 9 through 11, wherein the first message comprises an indication of a quantity of SNPNs in the set of SNPNs, a list of SNPNs for establishment of the dual wireless connection included in the set of SNPNs, a list of GINs associated with SNPNs for establishment of the dual wireless connection included in the set of SNPNs, or a combination thereof.

Aspect 13: The method of aspect 12, wherein the first message comprises an indication of whether the first message comprises the list of SNPNs, an indication of whether the first message comprises the list of GINs, an indication of whether the list of SNPNs comprises an identifier of the PLMN, an indication of whether the list of GINS comprises the identifier of the PLMN, or a combination thereof.

Aspect 14: The method of any of aspects 9 through 13, wherein the first message is a SOR-SNPN-SI message.

Aspect 15: An apparatus for wireless communication at a UE, comprising a processor; memory coupled with the processor; and instructions stored in the memory and executable by the processor to cause the apparatus to perform a method of any of aspects 1 through 14.

Aspect 16: An apparatus for wireless communication at a UE, comprising at least one means for performing a method of any of aspects 1 through 14.

Aspect 17: A non-transitory computer-readable medium storing code for wireless communication at a UE, the code comprising instructions executable by a processor to perform a method of any of aspects 1 through 14.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communication at a user equipment (UE), comprising:
establishing a first wireless connection with a first network via a public land mobile network;
selecting a standalone non-public network for establishment of a dual wireless connection between the UE and the first network, the dual wireless connection being via the standalone non-public network and the public land mobile network, the standalone non-public network selected from a set of standalone non-public networks associated with dual access of the first network; and
establishing a second wireless connection with the first network via the standalone non-public network to establish the dual wireless connection with the first network.

2. The method of claim 1, wherein selecting the standalone non-public network from the set of standalone non-public networks comprises:
selecting the standalone non-public network in accordance with a prioritized list of standalone non-public networks, at least a portion of the prioritized list of standalone non-public networks overlapping with the set of standalone non-public networks.

3. The method of claim 1, wherein selecting the standalone non-public network from the set of standalone non-public networks comprises:
selecting a group identifier in accordance with a prioritized list of group identifiers associated with the set of standalone non-public networks; and
selecting the standalone non-public network based at least in part on receiving, from the standalone non-public network, a broadcast associated with the group identifier.

4. The method of claim 1, further comprising:
operating in a mode associated with dual access of the first network via standalone non-public networks, wherein selecting the standalone non-public network from the set of standalone non-public networks is triggered based at least in part on operating in the mode.

5. The method of claim 1, further comprising:
receiving, from the public land mobile network, a UE route selection policy that triggers the selection of the standalone non-public network for establishment of the dual wireless connection between the UE and the first network.

6. The method of claim 1, wherein the set of standalone non-public networks are associated with the public land mobile network.

7. The method of claim 1, wherein a list comprising the set of standalone non-public networks comprises an identifier of the public land mobile network, the standalone non-public network selected from the set of standalone non-public networks in the list based at least in part on the list comprising the identifier of the public land mobile network.

8. The method of claim 1, wherein:
a first subset of standalone non-public networks of the set of standalone non-public networks correspond to standalone non-public networks included in a prioritized list of standalone non-public networks for establishment of the dual wireless connection,
a second subset of standalone non-public networks of the set of standalone non-public networks correspond to standalone non-public networks associated with a prioritized list of group identifiers, and
the first subset of standalone non-public networks is associated with a higher priority for selection to establish the dual wireless connection than the second subset of standalone non-public networks.

9. The method of claim 1, further comprising:
receiving a first message that indicates the set of standalone non-public networks.

10. The method of claim 9, further comprising:
replacing a second set of standalone non-public networks associated with dual access of the first network with the set of standalone non-public networks in response to receiving the first message.

11. The method of claim 9, further comprising:
transmitting a second message indicating a capability of the UE to update stored standalone non-public network information associated with selection of the standalone non-public network for establishment of the dual wireless connection, wherein the first message is received based at least in part on the capability of the UE to update the stored standalone non-public network information.

12. The method of claim 9, wherein the first message comprises an indication of a quantity of standalone non-public networks in the set of standalone non-public networks, a list of standalone non-public networks for establishment of the dual wireless connection included in the set of standalone non-public networks, a list of group identifiers associated with standalone non-public networks for establishment of the dual wireless connection included in the set of standalone non-public networks, or a combination thereof.

13. The method of claim 12, wherein the first message comprises an indication of whether the first message comprises the list of standalone non-public networks, an indication of whether the first message comprises the list of group identifiers, an indication of whether the list of standalone non-public networks comprises an identifier of the public land mobile network, an indication of whether the list of group identifiers comprises the identifier of the public land mobile network, or a combination thereof.

14. The method of claim 9, wherein the first message is a steering of roaming standalone non-public network selection information message.

15. An apparatus for wireless communication, comprising:
a processor;
memory coupled with the processor; and
instructions stored in the memory and executable by the processor to cause the apparatus to:
establish a first wireless connection with a first network via a public land mobile network;
select a standalone non-public network for establishment of a dual wireless connection between the apparatus and the first network, the dual wireless connection being via the standalone non-public network and the public land mobile network, the standalone non-public network selected from a set of standalone non-public networks associated with dual access of the first network; and
establish a second wireless connection with the first network via the standalone non-public network to establish the dual wireless connection with the first network.

16. The apparatus of claim 15, wherein the instructions to select the standalone non-public network from the set of standalone non-public networks are executable by the processor to cause the apparatus to:
select the standalone non-public network in accordance with a prioritized list of standalone non-public networks, at least a portion of the prioritized list of standalone non-public networks overlapping with the set of standalone non-public networks.

17. The apparatus of claim 15, wherein the instructions to select the standalone non-public network from the set of standalone non-public networks are executable by the processor to cause the apparatus to:
select a group identifier in accordance with a prioritized list of group identifiers associated with the set of standalone non-public networks; and
select the standalone non-public network based at least in part on receiving, from the standalone non-public network, a broadcast associated with the group identifier.

18. The apparatus of claim 15, wherein the instructions are further executable by the processor to cause the apparatus to:
operate in a mode associated with dual access of the first network via standalone non-public networks, wherein selecting the standalone non-public network from the set of standalone non-public networks is triggered based at least in part on operating in the mode.

19. The apparatus of claim 15, wherein the instructions are further executable by the processor to cause the apparatus to:
receive, from the public land mobile network, a user equipment (UE) route selection policy that triggers the selection of the standalone non-public network for establishment of the dual wireless connection between the apparatus and the first network.

20. The apparatus of claim 15, wherein the set of standalone non-public networks are associated with the public land mobile network.

21. The apparatus of claim 15, wherein a list comprising the set of standalone non-public networks comprises an identifier of the public land mobile network, the standalone non-public network selected from the set of standalone non-public networks in the list based at least in part on the list comprising the identifier of the public land mobile network.

22. The apparatus of claim 15, wherein:
a first subset of standalone non-public networks of the set of standalone non-public networks correspond to standalone non-public networks included in a prioritized list of standalone non-public networks for establishment of the dual wireless connection,
a second subset of standalone non-public networks of the set of standalone non-public networks correspond to standalone non-public networks associated with a prioritized list of group identifiers, and
the first subset of standalone non-public networks is associated with a higher priority for selection to establish the dual wireless connection than the second subset of standalone non-public networks.

23. The apparatus of claim 15, wherein the instructions are further executable by the processor to cause the apparatus to:
receive a first message that indicates the set of standalone non-public networks.

24. The apparatus of claim 23, wherein the instructions are further executable by the processor to cause the apparatus to:
replace a second set of standalone non-public networks associated with dual access of the first network with the set of standalone non-public networks in response to receiving the first message.

25. The apparatus of claim 23, wherein the instructions are further executable by the processor to cause the apparatus to:
transmit a second message indicating a capability of the apparatus to update stored standalone non-public network information associated with selection of the standalone non-public network for establishment of the dual wireless connection, wherein the first message is received based at least in part on the capability of the apparatus to update the stored standalone non-public network information.

26. The apparatus of claim 23, wherein the first message comprises an indication of a quantity of standalone non-public networks in the set of standalone non-public networks, a list of standalone non-public networks for establishment of the dual wireless connection included in the set of standalone non-public networks, a list of group identifiers associated with standalone non-public networks for establishment of the dual wireless connection included in the set of standalone non-public networks, or a combination thereof.

27. The apparatus of claim 26, wherein the first message comprises an indication of whether the first message comprises the list of standalone non-public networks, an indication of whether the first message comprises the list of group identifiers, an indication of whether the list of standalone non-public networks comprises an identifier of the public land mobile network, an indication of whether the list of group identifiers comprises the identifier of the public land mobile network, or a combination thereof.

28. The apparatus of claim 23, wherein the first message is a steering of roaming standalone non-public network selection information message.

29. An apparatus for wireless communication, comprising:
means for establishing a first wireless connection with a first network via a public land mobile network;
means for selecting a standalone non-public network for establishment of a dual wireless connection between the apparatus and the first network, the dual wireless connection being via the standalone non-public network and the public land mobile network, the standalone non-public network selected from a set of standalone non-public networks associated with dual access of the first network; and
means for establishing a second wireless connection with the first network via the standalone non-public network to establish the dual wireless connection with the first network.

30. A non-transitory computer-readable medium storing code for wireless communication, the code comprising instructions executable by a processor to:
establish a first wireless connection with a first network via a public land mobile network;
select a standalone non-public network for establishment of a dual wireless connection between a user equipment (UE) and the first network, the dual wireless connection being via the standalone non-public network and the public land mobile network, the standalone non-public network selected from a set of standalone non-public networks associated with dual access of the first network; and
establish a second wireless connection with the first network via the standalone non-public network to establish the dual wireless connection with the first network.
